(19) United States
(12) Patent Application Publication
(10) Pub. No.: US 2013/0321349 A1
(43) Pub. Date: Dec. 5, 2013

(54) METHOD AND APPARATUS FOR PREVENTING FALSE TOUCH

(71) Applicant: Samsung Electronics Co., Ltd., Suwon-si (KR)

(72) Inventors: Byung-Chul KIM, Seoul (KR); Jae-Hun JEONG, Hwaseong-si (KR)

(21) Appl. No.: 13/908,260

(22) Filed: Jun. 3, 2013

(30) Foreign Application Priority Data
Jun. 4, 2012 (KR) 10-2012-0059819

(51) Int. Cl. G06F 3/041

(52) U.S. Cl. CPC G06F 3/0418
USPC 345/178

(57) ABSTRACT

An electronic device for preventing a false touch and a method thereof are provided. An operation method of an electronic device includes identifying each node value detected in at least one node positioned in a range that is set on a basis of a node where a maximum node value is detected, identifying a number of nodes where node values equal to or greater than a set percentage of the maximum node value are detected among nodes within the set range, and, based on the number of nodes, determining whether to receive an input of a touch region on the node where the maximum node value is detected.

### PRIORITY

This application claims the benefit under 35 U.S.C. §119(a) of a Korean patent application filed on Jun. 4, 2012 in the Korean Intellectual Property Office and assigned Serial No. 10-2012-0059819, the entire disclosure of which is hereby incorporated by reference.

### BACKGROUND OF THE INVENTION

1. Field of the Invention

The present invention relates to a method and an apparatus for distinguishing a false touch and a true touch.

2. Description of the Related Art

Anyone who uses an electronic device receiving a touch input has experienced at least once a situation where a specific region of the electronic device is input regardless of a user's intention. For example, if a user was using an electronic device in a place where a lot of electromagnetic waves are generated, a false touch could occur due to radiation noise generated near the electronic device, although the user did not actually provide the touch input to a touch screen of the electronic device. Accordingly, to prevent the unintended false touch, several applications have been developed.

However, the use of the application for preventing the false touch results in another problem that a user should execute a procedure to identify whether a touch event is a true touch or a false touch every time. For example, although the user inputted a displayed call button to the touch screen of the electronic device to make a call with a specific called party, he/she has to separately input a password, etc., for identifying whether the touch event is a false touch or not.

Therefore, a need exists for the development of an apparatus for, although a user does not manually input whether it is a true touch or not, automatically determining whether it is the true touch or not in an electronic device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages below. Accordingly, an aspect of the present invention is to provide an apparatus and method for automatically determining whether an input touch is a true touch or a false touch, and preventing an undesired operation.

Another aspect of the present invention is to provide an apparatus and method for automatically determining whether it is a true touch or a false touch by proposing a differentiated nine-cell algorithm.

Another aspect of the present invention is to provide an apparatus and method for automatically determining whether it is a true touch or a false touch by proposing an original pattern algorithm.

The above aspects are achieved by providing a method and an apparatus for preventing a false touch.

In accordance with an aspect of the present invention, an operation method of an apparatus is provided. The method includes identifying each node value detected in at least one node positioned in a range that is set on a basis of a node where a maximum node value is detected, identifying a number of nodes where node values equal to or greater than a set percentage of the maximum node value are detected among nodes within the set range, and, based on the number of nodes, determining whether to receive an input of a touch region on the node where the maximum node value is detected.

The method may further include identifying each node value detected in at least one node, identifying that the detected node value has been varied, and searching any one node where the maximum node is detected among the at least one node.

The method may further include determining if the maximum node value is equal to or is greater than a set node value, if it is determined that the maximum node value is equal to or is greater than the set node value, receiving the input of the touch region on the node where the maximum node value is detected, and executing a function to be performed by receiving the input of the touch region.

The at least one node positioned within the set range may be eight nodes positioned closest to the node where the maximum node value is detected.

Based on the number of nodes, determining whether to receive the input of the touch region on the node where the maximum node value is detected may include, if it is determined that an identified number of nodes is less than a set count, receiving the input of the touch region on the node where the maximum node value is detected, and executing a function to be performed by receiving the input of the touch region.

Based on the number of nodes, determining whether to receive the input of the touch region on the node where the maximum node value is detected may include, if it is determined that an identified number of nodes is equal to or is greater than the set count, not receiving the input of the touch region on the node where the maximum node value is detected.

Each node may be an intersection of at least one X channel and at least one Y channel.

In accordance with another aspect of the present invention, an operation method of an electronic device is provided. The method includes identifying that all node values detected in at least one node positioned in a set range among detected node values have been varied, and identifying the varied node value and determining whether to receive the input of the touch region on at least one node positioned within the set range.

The method may further include identifying each node value detected in at least one node.

The at least one node positioned within the set range includes all nodes included in at least one X channel.

The identifying that the all node values detected in the at least one node positioned within the set range among the detected node values have been varied may include identifying that the node value detected in the at least one node positioned within the set range has been varied equal to or greater than a set node value, and identifying that a number of nodes varied equal to or greater than the set node value is equal to or is greater than a set count.

The identifying of the varied node value and determining whether to receive the input of the touch region on the at least one node positioned within the set range may include applying a pattern algorithm to at least one node positioned within the set range, and, as a result of applying the pattern algorithm, identifying the varied node value detected in the at least one node positioned within the set range.

The pattern algorithm may be defined according to the following equation below:

$$A - \frac{C}{B}$$

In the above equation, A denotes an each node value detected in each node, B denotes a value subtracting ‘1’ from the number of nodes within the set range, and C denotes a value subtracting maximum node value among node values detected in nodes within the set range from the total sum of node values detected in nodes within set range.

The identifying of the varied node value detected in the at least one node positioned within the set range as the result of applying the pattern algorithm may include searching for any one node where a maximum node value among node values detected in at least one node positioned within the set range is detected, identifying that the maximum node value is equal to or is greater than a set node value, receiving an input of a touch region on at least one node positioned within the set range, and executing a function to be performed by receiving the input of the touch region.

The identifying of the varied node value detected in at least one node positioned within the set range as the result of applying the pattern algorithm may include searching for any one node where a maximum node value among nodes values detected in at least one node positioned within the set range is detected, identifying that the maximum node value is less than a set node value, and not receiving the input of the touch region on the at least one node positioned within the set range.

The node may be at an intersection of at least one X channel and at least one Y channel.

In accordance with a further aspect of the present invention, an electronic device is provided. The device includes a processor unit and a memory. The processor unit identifies each node value detected in at least one node positioned in a range that is set on a basis of a node where a maximum node value is detected, identifies a number of nodes where node values equal to or greater than a set percent of the maximum node value are detected among nodes within the set range and, based on the number of nodes, determines whether to receive an input of a touch region on the node where the maximum node value is detected. The memory stores information controlled in the processor unit.

The processor unit may identify each node value detected in at least one node, identify that the detected node values have been varied, and search for any one node where the maximum node value is detected among the at least one node.

The processor unit may determine if the maximum node value is equal to or is greater than a set node value, and execute a function to be performed by receiving the input of the touch region, and may further include a touch screen for, if it is determined that the maximum node value is equal to or is greater than the set node value, receiving the input of the touch region on the node where the maximum node value is detected.

The at least one node positioned within the set range may be eight nodes closest to the node where the maximum node value is detected.

The device may further include a touch screen for, if it is determined that the number of nodes is less than a set count, receiving the input of the touch region on the node where the maximum node value is detected, and the processor unit may execute a function to be performed by receiving the input of the touch region.

If it is determined that the number of nodes is equal to or is greater than the set count, the touch screen may not receive the input of the touch region on the node where the maximum node value is detected.

The node may be at an intersection of at least one X channel and at least one Y channel.

In accordance with yet another aspect of the present invention, an electronic device is provided. The device includes a processor unit and a memory. The processor unit identifies that all node values detected in at least one node positioned in a set range among detected node values have been varied and, by identifying the varied node value, determines whether to receive an input of a touch region on at least one node positioned within the set range. The memory stores information controlled in the processor unit.

The processor unit may identify each node value detected in at least one node.

The at least one node positioned within the set range may include all nodes included in at least one X channel.

The processor unit may identify that the all node values detected in the at least one node positioned within the set range among the detected node values have been varied, identify that the node value detected in the at least one node positioned within the set range has been varied equal to or greater than a set node value, and identify that the node varied equal to or greater than the set node value is equal to or is greater than a set count.

The processor unit may apply a pattern algorithm to at least one node positioned within the set range and, as a result of applying the pattern algorithm, identify the varied node value detected in the at least one node positioned within the set range.

The pattern algorithm may be defined according to the following equation below:

$$A - \frac{C}{B}$$

In the above equation, A denotes each node value detected in each node, B denotes a value subtracting ‘1’ from a number of nodes within set range, and C denotes a value subtracting maximum node value among node values detected in nodes within set range from the total sum of node values detected in nodes within set range.

The processor unit may search for any one node where a maximum node value among node values detected in at least one node positioned within the set range is detected, identify that a maximum node value is equal to or is greater than a set node value, and execute a function to be performed by receiving the input of the touch region, and may further include a touch screen for receiving the input of the touch region on at least one node positioned within the set range.

The processor unit may identify the varied node value detected in at least one node positioned within the set range as the result of applying a pattern algorithm, search for any one node where a maximum node value among nodes values detected in at least one node positioned within the set range is detected, and identify that a maximum node value is less than a set node value, and may further include a touch screen not receiving the input of the touch region on the at least one node positioned within the set range.

The node may be the intersection of at least one X channel and at least one Y channel.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating an apparatus for preventing a false touch according to an exemplary embodiment of the present invention;

FIG. 2 is a diagram illustrating, after receiving a touch input, an exemplary apparatus identifying that a touch input is a true touch according to an exemplary embodiment of the present invention;

FIG. 3 is a diagram illustrating a nine-cell algorithm according to an exemplary embodiment of the present invention;

FIG. 4 is a diagram illustrating another nine-cell algorithm according to an exemplary embodiment of the present invention;

FIG. 5 is a diagram illustrating another nine-cell algorithm according to an exemplary embodiment of the present invention;

FIG. 6 is a diagram illustrating yet another nine-cell algorithm according to an exemplary embodiment of the present invention;

FIG. 7 is a diagram illustrating a pattern algorithm according to an exemplary embodiment of the present invention;

FIG. 8 is a diagram illustrating another pattern algorithm according to an exemplary embodiment of the present invention;

FIG. 9 is a flowchart illustrating a nine-cell algorithm according to an exemplary embodiment of the present invention;

FIG. 10 is a flowchart illustrating a pattern algorithm according to an exemplary embodiment of the present invention; and

FIG. 11 is a block diagram illustrating an apparatus according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

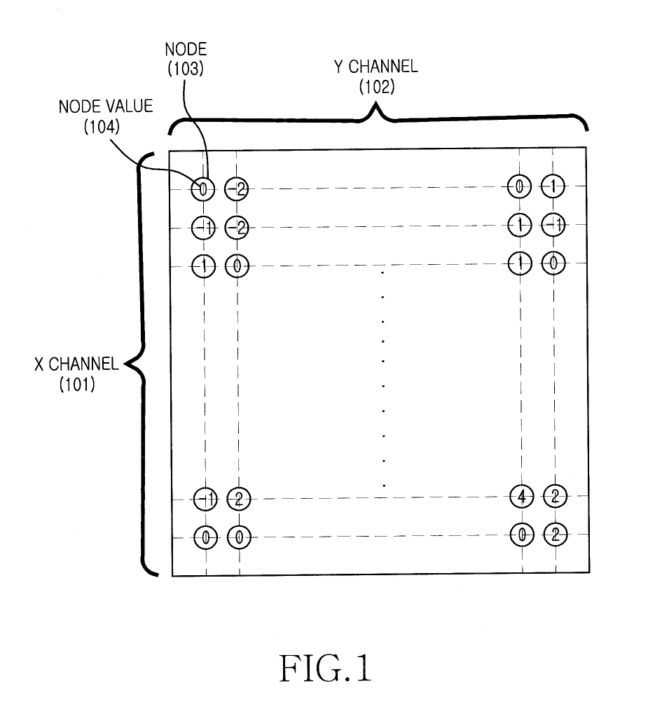

FIG. 1 is a diagram illustrating an apparatus for preventing a false touch according to an exemplary embodiment of the present invention.

Referring to FIG. 1, an electronic device for preventing a false touch according to an exemplary embodiment of the present invention includes an X channel 101, a Y channel 102, a node 103, and a node value 104 detected in the node 103.

First, the X channel 101, which is defined as a capacitor Transmission (Tx) driver channel, is a line providing a capacitance in a panel. In more detail, when viewing from the front of the electronic device, at least one X channel 101 parallel with the X axis is provided in the electronic device. The number of X channels 101 may be different depending on the physical characteristics of the electronic device. For example, when a touch screen of the electronic device is of 3.2 inches in size, twelve X channels 101 may be provided and, when the touch screen of the electronic device is of 5 inches in size, fourteen X channels 101 may be provided. These examples represent a number of X channels 101 capable of being commonly provided, and the number of X channels 101 is not fixed to a size of the touch screen of the electronic device.

The Y channel 102, which is defined as a capacitor Reception (Rx) input channel, is a line detecting the capacitance of the capacitor in each X channel 101. In more detail, when viewing from the front of the electronic device, at least one Y channel 102 parallel with the Y axis may be provided within the electronic device. Similar to the number of X channels 101, the number of Y channels 102 may be different depending on the physical characteristics of the electronic device. For example, when a touch screen of the electronic device is of 3.2 inches in size, eight Y channels 102 may be provided and, when the touch screen of the electronic device is of 5 inches in size, sixteen Y channels 102 may be provided. These examples represent the number of Y channels 102 capable of being commonly provided, and the number of Y channels 102 is not fixed to the size of the touch screen of the electronic device.

The node 103, configured at the intersection of the X channel 101 and Y channel 102, has a node value 104 detected in a corresponding node. In more detail, each node 103 detects a variance computation based on the amount of capacitance at each corresponding node. For example, an application is provided for displaying the variance computation amount so that a user can visually see the variance computation amount. That is, the node value 104 is displayed within each node 103 and represents the variance computation amount of the capacitance at the corresponding node. For example, a node value of ‘0’ means a variance computation amount of the capacitance at a corresponding node is displayed using a numerical value of ‘0’. A node value of ‘2’ means a variance computation at a corresponding node displays a numerical value of ‘2’. A large node value at the corresponding node indicates a large capacitance and can be regarded as having received a touch input from a user at the node. On the other hand, a small node value at the corresponding node indicates a small capacitance and can be regarded as having not having received a touch input from the user.

The electronic device includes at least two algorithms for identifying whether it has received an input of a true touch or a false touch. If a detected node value is equal to or greater than a set node value, the electronic device detects the touched region as a true touch. That is, if the electronic device receives a detected node value that is less than the set node value, the two algorithms may be applied to determine whether it has received an input of a true touch or a false touch. In the related art, a touch input occurs regardless of a user's intention, causing an inconvenience to the user. In an exemplary embodiment of the present invention, when a touch input occurs, it is capable of determining whether the touch input is a true touch or a false touch using the two algorithms.

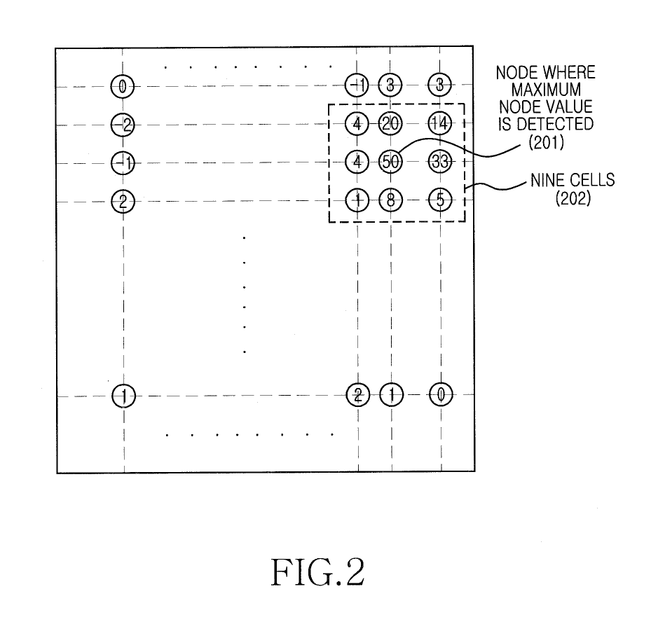

FIG. 2 is a diagram illustrating an exemplary embodiment in which, after receiving a touch input, an electronic device determines that the touch input is a true touch according to an exemplary embodiment of the present invention.

Referring to FIG. 2, when viewing from the front of the electronic device, at least one X channel parallel with the X axis and at least one Y channel parallel with the Y axis can be provided within the electronic device.

Each intersection of the X channel and the Y channel is a node that determines the variance computation amount of the capacitance at that node. A separate application for displaying the variance computation amount is provided so that a user can see the variance computation amount. That is, the node value is displayed within each node and represents the variance computation amount of the capacitance at that node. A large node value corresponds to a large capacitance and can be regarded as having received a user input touch of a touch region in proximity to that node. A small node value corresponds to a small capacitance and can be regarded as not having received the user input touch in proximity to that node.

FIG. 2 illustrates an exemplary embodiment in which, after receiving a touch input, the electronic device identifies that the touch input is a true touch. First, the electronic device determines each node value in at least one node, identifies that the detected node values have been varied, and searches for a maximum node value among the nodes. That is, the electronic device monitors node values that vary in real-time. If it is identified that the node values have been varied, the electronic device searches for a maximum node value among the varied node values. After that, the electronic device determines if the maximum node value is equal to or is greater than a set node value. If it is determined that the maximum node value is equal to or is greater than the set node value, the electronic device receives an input of a touch region on a node where the maximum node value is detected, and executes a function to be performed corresponding to that node. In more detail, if it is determined in the electronic device that at least one node has a node value equal to or greater than the set node value, the electronic device determines that it has received an input of a true touch, receives the input of the touch region at the node where the maximum node value is detected, and executes the function to be performed corresponding to that node. As will be described below, if it is determined that the maximum node value detected among at least one node is equal to or is greater than the set node value, the electronic device can just identify a true touch without the need to apply additional algorithms.

In the example illustrated in FIG. 2, the electronic device monitors node values in real-time. If it is identified that the node values vary, the electronic device searches for a node 201 having a maximum node value. After that, the electronic device determines whether the node value of node 201 is equal to or is greater than the set node value. Assuming that the set node value is equal to ‘25’, because the node value in the node 201 is greater than the set node value of ‘25’, the electronic device determines that it has received an input of a true touch at the node 201 where the maximum node value is detected and executes a function to be performed corresponding to that node. Accordingly, additional processing to detect a touch input is not applied.

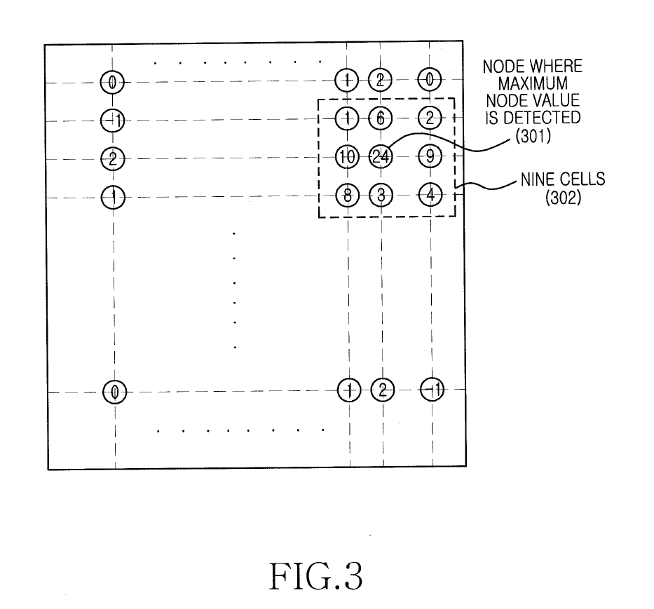

FIG. 3 is a diagram illustrating a nine-cell algorithm according to an exemplary embodiment of the present invention.

Referring to FIG. 3, the electronic device is composed of at least one X channel and at least one Y channel and a node is provided at each intersection of the X channel and the Y channel. Here, the number of nodes is a relative numerical value that can be different depending on the number of X channels and Y channels. That is, as the number of X channels and Y channels increases, the number of nodes increases. In contrast, as the number of X channels and Y channels decreases, the number of nodes decreases. Accordingly, the number of nodes can be different depending on a product applied.

Referring to FIG. 3, a node at the intersection of an X channel and a Y channel provided in the electronic device and a node value that is detected in each node is displayed. As described above, each node detects a variance computation amount of a capacitance at each node. A separate application is provided for displaying the variance computation amount so that a user can see the variance computation amount. First, the electronic device identifies each node value detected in at least one node, identifies that the detected node values vary, and searches for the nodes for a node 301 having a maximum node value. That is, the electronic device monitors node values that vary in real-time. If it is identified that the node values vary, the electronic device searches for the node 301 having a maximum node value among the varied node values and determines if the maximum node value is equal to or is greater than a set node value. If it is determined that the maximum node value is equal to or is greater than the set node value, the electronic device determines to receive a touch input at the node 301 where the maximum node value is detected, and executes a function to be performed. In more detail, if it is determined in the electronic device that the maximum node value detected is equal to or is greater than the set node value, the electronic device determines that it has received an input of a true touch, receives the input of the touch region on the node where the maximum node value is detected, and executes the function to be performed.

By contrast, if it is determined in the electronic device that the maximum node value is less than the set node value, the electronic device applies an exemplary nine-cell algorithm to determine if it has received an input of a true touch or a false touch. In more detail, if it is determined in the electronic device that the maximum node value detected among at least one node is less than the set node value, the electronic device identifies node values within a region of nodes or a set range of nodes with respect to node 301 where the maximum node value is detected. Here, the nodes positioned within the set range of nodes can be defined as eight nodes positioned closest to the node 301 where the maximum node value is detected, without considering the node 301 where the maximum node value is detected. Also, nine cells 302 can be defined as a total of nine nodes including the node 301 and eight nodes positioned closest to the node 301. In the example illustrated in FIG. 3, the nodes within the set range of nodes are the eight nodes closest to a node 301, without considering the node 301 where the maximum node value is detected. As illustrated in FIG. 3, the nodes positioned within the set range have node values of ‘1’, ‘6’, ‘2’, ‘9’, ‘4’, ‘3’, ‘8’, and ‘10’ in a diagonal direction and an up/down direction with respect to node 301. That is, the electronic device identifies the node values ‘1’, ‘6’, ‘2’, ‘9’, ‘4’, ‘3’, ‘8’, and ‘10’, which are detected in eight nodes closest to node 301 where the maximum node value is detected.

After that, the electronic device identifies the number of nodes within the set range of nodes that have node values equal to or greater than a set percentage of the maximum node value (i.e., a scaled value of the maximum node value). In more detail, the electronic device counts the number of nodes having the node values that are equal to or greater than the set percentage of the maximum node value from the eight nodes closest to the node 301 where the maximum node value is detected. For example, as illustrated in FIG. 3, assuming that the set percentage is 30 percent and the maximum node value is equal to ‘24’, the set percentage of the maximum node value is a scaled value of ‘7.2’. Accordingly, among eight nodes positioned closest to the node 301, there are three nodes that having node values of ‘10’, ‘9’, and ‘8’ and that are equal to or greater than the set percentage of the maximum node value, which is ‘7.2’.

After counting the number of nodes having the node values equal to or greater than the set percentage of the maximum node value among eight nodes closest to the node 301, the electronic device determines whether to receive an input of a touch region on the node where the maximum node value is detected. In more detail, the electronic device determines if the number of nodes where the node values equal to or greater than the set percentage of the maximum node value is less than a set count (i.e., a threshold count). In the aforementioned example, because there are three nodes with nodes values equal to or greater than the set percentage of the maximum node value within the set range, the electronic device compares the counted nodes with the set count. Assuming that the set count is five, the electronic device determines that the count of three nodes is less than the set count of five, and determines to receive an input of a touch region on the node 301 having the maximum node value and executes a function to be performed. Accordingly, in this exemplary embodiment, the electronic device receives an input of a touch region on the node 301 where the maximum node value is detected, and performs a function to be performed.

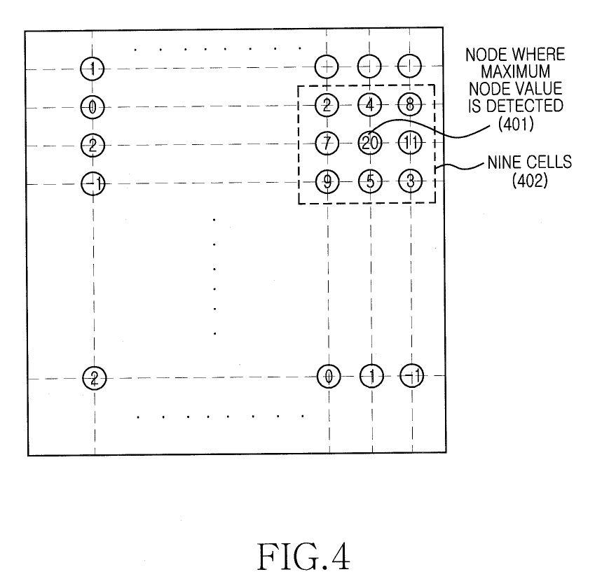

FIG. 4 is a diagram illustrating another nine-cell algorithm according to an exemplary embodiment of the present invention.

Referring to FIG. 4, the electronic device is composed of at least one X channel and at least one Y channel. A node is provided at each intersection of the X channel and the Y channel. Here, the number of nodes is a relative numerical value that can be different depending on the number of X channels and Y channels. That is, as the number of X channels and Y channels increases, the number of nodes that are the intersections of respective channels increases. In contrast, as the number of X channels and Y channels decreases, the number of nodes that are the intersections of respective channels decreases. Accordingly, the number of nodes can be different depending on the electronic device.

Referring to FIG. 4, a node that is the intersection of an X channel and a Y channel provided in the electronic device and a node value that is detected in each node are displayed. As described above, each node detects a variance computation amount of a capacitance at each corresponding node. Accordingly, a separate application is provided for displaying the variance computation amount by a numerical value so that a user can see the variance computation amount. First, the electronic device identifies a node value detected in at least one node, identifies that the detected node values vary, and searches for a maximum node value from the nodes. That is, the electronic device monitors node values that vary in real-time. If it is identified that the node values vary, the electronic device searches for a node 401 having a maximum node value among the varied node values. After that, the electronic device determines if the maximum node value is equal to or is greater than a set node value. If it is determined that the maximum node value is equal to or is greater than the set node value, the electronic device determines to receive an input of a touch region on the node 401 where the maximum node value is detected, and executes a function to be performed. In more detail, if it is determined in the electronic device determines that the maximum node value is equal to or is greater than the set node value, the electronic device determines that it has received an input of a true touch, receives an input of a touch region on the node where the maximum node value is detected, and executes a function to be performed.

In contrast, if it is determined in the electronic device that the maximum node value detected among at least one node is less than the set node value, the electronic device applies an exemplary nine-cell algorithm to determine if it has received an input of a true touch a false touch. In more detail, if it is determined in the electronic device that the maximum node value is less than the set node value, the electronic device identifies node values within a set range of nodes based on the node 401 where the maximum node value is detected. Here, the set range may be eight nodes closest to the node 401 where the maximum node value is detected without considering the node 401. In another example, nine cells 402 can be defined as a total of nine nodes including the node 401 where the maximum node value is detected and eight nodes positioned closest to the node 401. In the example illustrated in FIG. 4, the set range includes the eight nodes positioned closest to a node 401 where a maximum node value is detected without considering the node 401. As illustrated in FIG. 4, the eight nodes have node values of ‘2’, ‘4’, ‘8’, ‘11’, ‘3’, ‘5’, ‘9’, and ‘7’ in a diagonal direction and an up/down direction with respect to node 401 where the maximum node value is detected. That is, the electronic device identifies the node values ‘2’, ‘4’, ‘8’, ‘11’, ‘3’, ‘5’, ‘9’, and ‘7’, which are detected as eight nodes closest to the node 401 where the maximum node value is detected.

After that, the electronic device counts the number of nodes within the set range having node values that are equal to or greater than a percentage of the maximum node value. That is, the electronic device identifies a number of nodes having node values equal to or greater than the percentage or a scaled value of the maximum node value among eight nodes closest to the node 401 where the maximum node value is detected. In the example illustrated in FIG. 4, assuming that the set percentage is 30 percent, because the maximum node value is equal to ‘20’, the set percentage of the maximum node value is a scaled value of ‘6’. Accordingly, among eight nodes positioned closest to the node 401, there are four nodes having node values ‘7’, ‘8’, ‘9’, and ‘11’, respectively, that are detected to have node values equal to or greater than the scaled value of ‘6’.

After counting the number of nodes having node values equal to or greater than the set percentage of the maximum node value, the electronic device determines whether to receive an input of a touch region on the node 401 where the maximum node value is detected. That is, the electronic device determines if the number of nodes in the set range having the node values equal to or greater than the set percentage of the maximum node value is less than a set count. In the aforementioned example, because there are four nodes having values that are equal to or greater than the set percentage of the maximum node value within the set range, the electronic device compares the number of identified nodes with the threshold count. Assuming that the threshold count is five, the electronic device determines that the four nodes having values equal to or greater than the set percentage of the maximum node value is less than the set count of five and determines to receive an input of a touch region on the node where the maximum node value is detected, and executes a function to be performed. Accordingly, in this exemplary embodiment, the electronic device receives an input of a touch region on the node 401 where the maximum node value is detected, and performs a function to be performed.

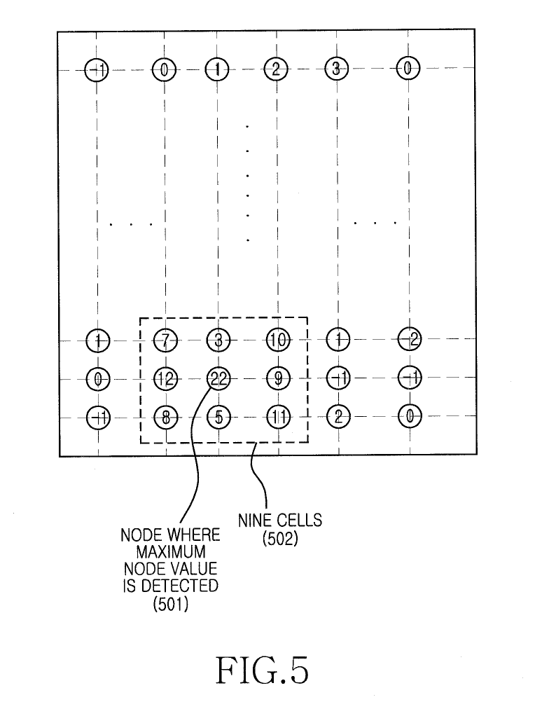

FIG. 5 is a diagram illustrating another nine-cell algorithm according to an exemplary embodiment of the present.

Referring to FIG. 5, the electronic device is composed of at least one X channel and at least one Y channel. A node is provided at each intersection of the X channel and the Y channel. Here, the number of nodes is a relative numerical value that can be different depending on the number of X channels and Y channels. That is, as the number of X channels and Y channels increases, the number of nodes that are the intersections of respective channels increases. In contrast, as the number of X channels and Y channels decreases, the number of nodes that are the intersections of respective channels decreases. Accordingly, the number of nodes can be different depending on the electronic device.

Referring to FIG. 5, a node at each intersection of an X channel and a Y channel are provided in the electronic device and a node value is detected in each node and displayed. As described above, each node detects a variance computation amount of a capacitance at each corresponding node. A separate application is provided for displaying the variance computation amount. First, the electronic device identifies a node value detected in at least one node, identifies that the detected node values vary, and searches for a node having a maximum node value. In detail, the electronic device monitors node values that are vary in real-time. If the node values vary, the electronic device searches for a node 501 for a maximum node value. After that, the electronic device determines if the maximum node value is equal to or is greater than a set node value. If it is determined that the maximum node value is equal to or is greater than the set node value, the electronic device receives an input of a touch region on a node where the maximum node value is detected, and executes a function to be performed. In more detail, if it is determined in the electronic device that the node where the maximum node value is detected is equal to or is greater than the set node value, the electronic device determines that it has received an input of a true touch, receives an input of a touch region on the node where the maximum node value is detected, and executes a function to be performed.

In contrast, if it is determined in the electronic device that the maximum node value detected among at least one node is less than the set node value, the electronic device applies an exemplary nine-cell algorithm to determine if it has received an input of a true touch or a false touch. That is, if it is determined in the electronic device that the maximum node value detected among the nodes is less than the set node value, the electronic device identifies node values detected within a set range of the node 501 where the maximum node value is detected. In one example, the set range can be defined as eight nodes closest to the node where the maximum node value is detected, without considering the node where the maximum node value is detected. In another example, nine cells 502 can be defined as a total of nine nodes including the node 501 where the maximum node value is detected and eight nodes closest to the node 501 where the maximum node value is detected. In the example illustrated in FIG. 5, the nodes positioned within the set range are eight nodes closest to the node 501 where a maximum node value is detected, without considering the node 501 where the maximum node value is detected. As illustrated in FIG. 5, the nodes within the set range have node values of ‘7’, ‘3’, ‘10’, ‘9’, ‘11’, ‘5’, ‘8’, and ‘12’ in a diagonal direction and an up/down direction with respect to the node 501 where the maximum node value is detected. That is, the electronic device identifies the node values ‘7’, ‘3’, ‘10’, ‘9’, ‘11’, ‘5’, ‘8’, and ‘12’, as the eight nodes closest to the node 501 where the maximum node value is detected.

After that, the electronic device identifies the number of nodes having node values equal to or greater than a set percentage or a scaled value of the maximum node value among the nodes within the set range. That is, the electronic device identifies the number of nodes having the node values that are equal to or greater than the set percentage of a scaled value of the maximum node value from among the eight nodes closest to the node where the maximum node value is detected. In the example illustrated in FIG. 5, assuming that the set percentage is 30 percent, because the maximum node value is equal to ‘22’, the set percentage of the maximum node value or scaled value is ‘6.6’. Accordingly, among eight nodes positioned in the closest places on a basis of the node 501 where the maximum node value is detected, the number of nodes where node values equal to or greater than the set percent ‘6.6’ of the maximum node value are detected is identified as a total of six nodes where the node values of ‘7’, ‘8’, ‘9’, ‘10’, ‘11’, and ‘12’ are detected equal to or greater than the scaled value of ‘6.6’, respectively.

After identifying the number of nodes where the node values equal to or greater than the set percentage of the maximum node value are detected among eight nodes closest to the node where the maximum node value is detected, the electronic device counts the number of nodes to determine whether to receive an input of a touch region on the node where the maximum node value is detected. That is, the electronic device determines if the number of nodes having node values equal to or greater than the set percentage of the maximum node value are detected among the nodes within the set range is less than a set count. In the aforementioned example, because the number of nodes having nodes values equal to or greater than the set percentage of the maximum node value is six within the set range, the electronic device compares the identified six nodes with the set count. Assuming that the set count is equal to ‘5’, the electronic device determines that the six nodes in the set range having node values equal to or greater than the set percent of the maximum node value within the set range is greater than the set count of five and determines not to receive an input of a touch region on the node where the maximum node value is detected. Accordingly, in this exemplary embodiment, the electronic device does not receive an input of a touch region on the node 501 where the maximum node value is detected.

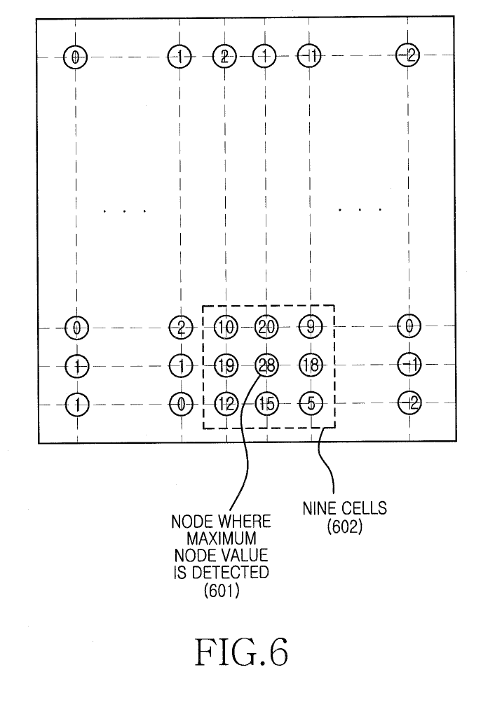

FIG. 6 is a diagram illustrating yet another nine-cell algorithm according to an exemplary embodiment of the present invention.

Referring to FIG. 6, the electronic device is composed of at least one X channel and at least one Y channel. A node is provided at each intersection of the X channel and the Y channel. Here, the number of nodes is a relative numerical value that can be different depending on the number of X channels and Y channels. That is, as the number of X channels and Y channels increases, the number of nodes that are the intersections of respective channels increases. In contrast, as the number of X channels and Y channels decreases, the number of nodes that are the intersections of respective channels decreases. Accordingly, the number of nodes can be different depending on a product applied.

Referring to FIG. 6, a node that is at each intersection of an X channel and a Y channel provided in the electronic device and a node value that is detected in each node are displayed. As described above, each node detects a variance computation amount of a capacitance associated with a corresponding node. A separate application for displaying the variance computation amount is provided so that a user can see the variance computation amount. First, the electronic device identifies the node value detected in at least one node, determines if the detected node values vary, and searches for the nodes for a maximum node value. That is, the electronic device monitors node values that vary in real-time. If the node values vary, the electronic device searches for a node 601 having a maximum node value among the varied node values. After that, the electronic device determines if the node value of the node 601 having the maximum node value is equal to or is greater than a set node value. If the maximum node value is equal to or is greater than the set node value, the electronic device determines to receive an input of a touch region on the node 601 where the maximum node value is detected, and executes a function to be performed. That is, if it is determined that the maximum node value is equal to or is greater than the set node value, the electronic device determines that it has received an input of a true touch, receives an input of a touch region on the node 601 where the maximum node value is detected, and executes a function to be performed.

In contrast, if it is determined in the electronic device that the maximum node value detected among at least one node is less than the set node value, the electronic device applies the nine-cell algorithm proposed in the present invention so as to determine if it has received an input of a true touch or if it has received an input of a false touch. If it is determined that the node 601 having the detected maximum node value is less than the set node value, the electronic device identifies node values within a set range with respect to the node 601 where the maximum node value is detected. In this example, the nodes positioned within the set range are positioned closest to the node 601 where the maximum node value is detected, without considering the node 601 where the maximum node value is detected. Nine cells 602 can be defined as the nine nodes including the node 601 where the maximum node value is detected and eight nodes positioned closest to the node 601 where the maximum node value is detected. In the example illustrated in FIG. 6, the nodes within the set range are the eight nodes positioned closest to the node 601 where a maximum node value is detected, without considering the node 601 where the maximum node value is detected. In this example, the nodes positioned within the range have node values of ‘10’, ‘20’, ‘9’, ‘18’, ‘5’, ‘15’, ‘12’, and ‘19’ in a diagonal direction and an up/down direction with respect to the node 601 where the maximum node value is detected. That is, the electronic device identifies the node values ‘10’, ‘20’, ‘9’, ‘18’, ‘5’, ‘15’, ‘12’, and ‘19’ in eight nodes closest to the node 601 where the maximum node value is detected.

After that, the electronic device identifies the number of nodes having node values equal to or greater than a set percentage or a scaled value of the maximum node value among the nodes within the set range. That is, the electronic device identifies the number of nodes where the node values equal to or greater than the set percentage of the maximum node value among eight nodes positioned closest to the node 601 where the maximum node value is detected. In the example illustrated in FIG. 6, assuming that the set percentage is 30 percent, because the maximum node value is equal to ‘28’, the set percent of the maximum node value is a scaled value of ‘8.4’. Accordingly, among eight nodes positioned closest to the node 601 where the maximum node value is detected, there are seven nodes having the node values ‘9’, ‘10’, ‘12’, ‘15’, ‘18’, ‘19’, and ‘20’ greater than the scaled value of ‘8.4’, respectively.

After identifying the number of nodes where the node values are equal to or greater than the scaled value, the electronic device compares the number of nodes to determine whether to receive an input of a touch region on the node 601 where the maximum node value is detected. For example, the electronic device determines if the number of nodes where the node values equal to or greater than the scaled value is less than a set count. In the aforementioned example, because seven nodes have nodes values equal to or greater than the set percent of the maximum node value, the electronic device compares the identified seven with the set count. Assuming that the set count is five, the electronic device determines that seven nodes have node values equal to or greater than the set percentage of the maximum node value and, therefore, determines to not receive an input of a touch region on the node 601 where the maximum node value is detected.

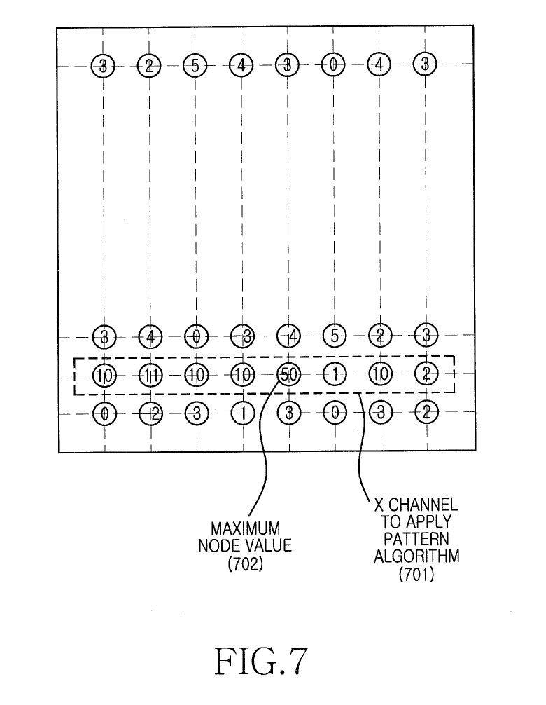

FIG. 7 is a diagram illustrating a pattern algorithm according to an exemplary embodiment of the present invention.

The exemplary pattern algorithm proposed identifies varied node values by each X channel and determines whether a touch input is a true input or a false input. First, the electronic device identifies a node value in at least one node and all node values within a range of the detected node values that vary. In this example, the electronic device identifies that all node values in a corresponding X channel vary. That is, the nodes positioned within the set range can be defined as all nodes in at least one X channel. That is, the electronic device determines whether to apply the pattern algorithm only when the electronic device identifies that all node values included in the X channel among a plurality of provided X channels vary. If all node values included in the X channel vary, the pattern algorithm determines if a touch input is a true input or a false input, preventing erroneous operation.

If all node values included in the corresponding X channel vary, the electronic device determines if the node values within the set range are equal to or greater than a set node value and then determines if the number of nodes having node values equal to or greater than the set node value is equal to or is greater than a set count. That is, the electronic device identifies the number of nodes having node values equal to or greater than the set node value from all node values in the X channel. If the number of nodes having the node values equal to or greater than the set node value is equal to or is greater than the set count, the electronic device applies a pattern algorithm to determine a true touch or a false touch. In the example illustrated in FIG. 7, assuming that the set node value is equal to ‘10’ and the set count is five, an X channel 701 has node values of ‘10’, ‘11’, ‘10’, ‘10’, ‘50’, ‘1’, ‘10’, and ‘2’ and will apply the pattern algorithm. That is, in the X channel 701 there are six nodes having node values equal to or greater than the set node value ‘10’, which is greater than the set count of five and, therefore, the electronic device applies the pattern algorithm to determine whether a touch input is a true input or a false input.

Next, the electronic device identifies the varied node values and determines whether to receive an input of a touch region on at least one node positioned within the set range. In more detail, the electronic device applies the pattern algorithm to at least one node positioned within the set range, and identifies a varied node value in at least one node positioned within the set range. Here, the pattern algorithm is determined by Equation 1 below.

$$A - \frac{C}{B} \qquad Equation 1$$

In Equation 1, A represents each node value detected in each node, B is a value formed by subtracting ‘1’ from the number of nodes within the set range, and C is a value formed by subtracting a maximum node value of the node values within the set range from the total sum of node values detected in the nodes within the set range.

In the example illustrated in FIG. 7, to obtain a ‘C’ value, the total sum of node values detected in nodes within the X channel 701 is a value of ‘104’. Here, the ‘C’ value is derived as ‘54’ by subtracting a maximum node value 702 of ‘50’ from among the node values within the X channel 701 from the total sum of the node values within the X channel 701, which is ‘104’. Accordingly, by dividing the ‘C’ value of ‘54’ by a ‘B’ value of ‘7’, a value of approximately ‘7.7’ is derived and is rounded to generate an integer of ‘8’. By again subtracting a value of ‘8’ from the node values ‘10’, ‘11’, ‘10’, ‘10’, ‘50’, ‘1’, ‘10’, and ‘2’ of the X channel 701, scaled node values ‘2’, ‘3’, ‘2’, ‘2’, ‘42’, ‘−7’, ‘2’, and ‘−6’ are obtained, respectively.

Next, the electronic device searches for one node where the maximum node value among the scaled node values detected in at least one node positioned within the set range. If it is identified that the maximum node value of the scaled node values is equal to or is greater than the set node value, the electronic device executes a function to be performed by receiving an input of a touch region on at least one node positioned within the set range. In the aforementioned example, assuming that the set node value is equal to ‘10’, because the maximum node value is equal to ‘42’ among the node values ‘2’, ‘3’, ‘2’, ‘2’, ‘42’, ‘−7’, ‘2’, and ‘−6’ that are obtained after the pattern algorithm is applied, and the maximum node value ‘42’ is greater than the set node value ‘10’ and the electronic device determines to receive the input of a touch region and executes a function corresponding to the input of a touch region on the X channel 701.

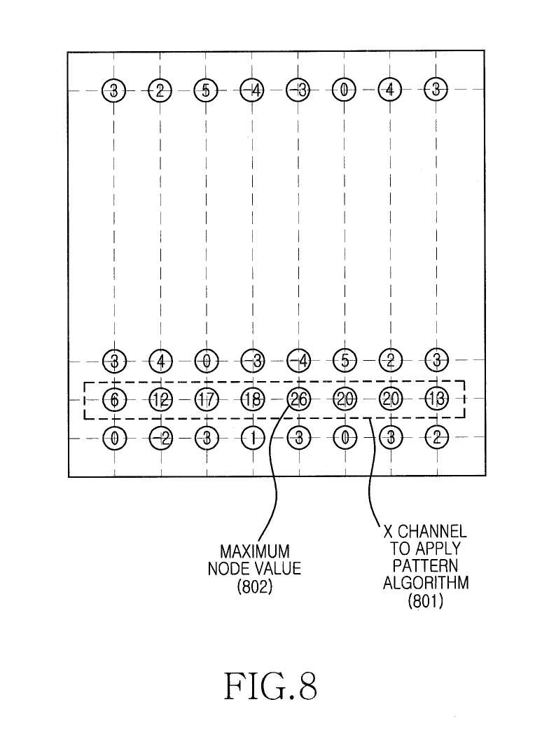

FIG. 8 illustrates a pattern algorithm according to an exemplary embodiment of the present invention.

The pattern algorithm proposed in an exemplary embodiment of the present invention identifies varied node values in each X channel and determines whether a touch input is a true input or a false input. First, the electronic device identifies each node value detected in at least one node and determines that all node values within a set range vary. In more detail, the electronic device identifies that node values in an X channel have been varied. Here, the one node within the set range included in at least one X channel among at least one X channel. That is, the electronic device determines whether to apply the pattern algorithm only when the electronic device identifies that all node values included in an X channel have been varied. If it is identified by X channel that all node values included in the corresponding X channel have been varied, the pattern algorithm proposed in an exemplary embodiment of the present invention determines if a touch input is a true input or a false input to thereby prevent erroneous operation.

If all node values included in the corresponding X channel have been varied, the electronic device identifies that a node value within the set range has been varied equal to or greater than a set node value and then counts the number of the nodes that are equal to or greater than the set node value and then determines if the count of nodes is equal to or is greater than a set count. That is, the electronic device identifies the number of nodes from all node values in the X channel having node values equal to or greater than the set node value. If the number of nodes having the node values equal to or greater than the set node value among the node values provided in the X channel is equal to or is greater than the set count, the electronic device applies the pattern algorithm to detect a true touch or a false touch. In the example illustrated in FIG. 8, assuming that the set node value is equal to ‘10’ and the set count is five, an X channel having node values of ‘6’, ‘12’, ‘17’, ‘18’, ‘26’, ‘20’, ‘20’, and ‘13’ in an X channel 801 will apply the pattern algorithm because there are seven nodes having node values equal to or greater than the set node value ‘10’, which is greater than the set count of five and the electronic device applies the pattern algorithm to determine whether the touch input is the true input or the false input.

Next, the electronic device identifies the varied node value and determines whether to receive an input of a touch region on a node within the set range. In more detail, the electronic device applies the pattern algorithm to at least one node within the set range, and identifies the varied node value detected in at least one node positioned within the set range as described above in connection with Equation 1.

In the example illustrated in FIG. 8, to obtain a ‘C’ value, the total sum of node values detected in nodes within the X channel 801 is derived as a value of ‘132’. Here, the ‘C’ value is derived as ‘106’ by subtracting a maximum node value 802 of ‘26’ from the node values in the X channel 801 from the total sum ‘132’ of the node values within the X channel 801, which is ‘132’. Accordingly, by dividing the ‘C’ value of ‘106’ by a ‘B’ value of ‘7’, a value of about ‘15.14’ is derived and is rounded to an integer of ‘15’. By again subtracting a value of ‘15’ from each of the node values ‘6’, ‘12’, ‘17’, ‘18’, ‘26’, ‘20’, ‘20’, and ‘13’ of the X channel 801, scaled node values ‘−9’, ‘−3’, ‘2’, ‘3’, ‘11’, ‘5’, ‘5’, and ‘−2’ are obtained in order, respectively.

Next, the electronic device searches for the maximum node from the nodes within the set range. If the maximum node value is equal to or is greater than the set node value, the electronic device determines to receive an input of a touch region on at least one node with the maximum value and execute a function. In the aforementioned example, assuming that the set node value is equal to ‘12’, because the maximum node value is equal to ‘11’ among the scaled node values ‘−9’, ‘−3’, ‘2’, ‘3’, ‘11’, ‘5’, ‘5’, and ‘−2’ that are obtained after the pattern algorithm is applied, the electronic device does not receive an input of a touch region on the X channel 801 because the scaled maximum node value of ‘11’ is less than the set node value of ‘12’.

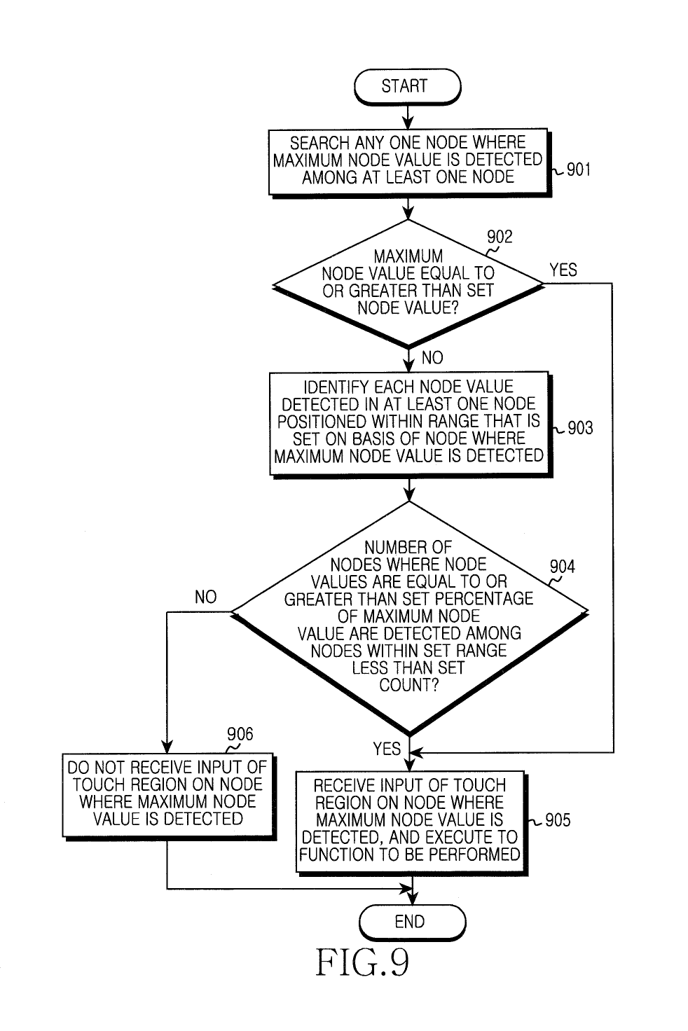

FIG. 9 is a flowchart illustrating a nine-cell algorithm according to an exemplary embodiment of the present invention.

Referring to FIG. 9, in step 901, an electronic device searches for any one node where a maximum node value is detected among at least one node. That is, the electronic device identifies each node value detected in at least one node, identifies that the detected node values vary, and searches for any one node where the maximum node value is detected among at least one node. Thus, the electronic device monitors node values that vary in real-time. If it is identified that the node values have been varied, the electronic device searches a maximum node value among the varied node values.

After searching for any one node where the maximum node value is detected among at least one node, in step 902, the electronic device determines if the maximum node value is equal to or is greater than a set node value. As described above, the electronic device compares the set node value with the maximum node value to determine whether to apply a detection algorithm. That is, when it is determined that the maximum node value is equal to or is greater than the set node value, the electronic devices determines that a touch input is a true touch. On the other hand, when the maximum node value is less than the set node value, the electronic device applies an exemplary detection algorithm to determine whether the touch input is a true touch or a false touch.

If it is determined in step 902 that the maximum node value is less than the set node value, in step 903, the electronic device identifies each node value detected in at least one node positioned within a range that is set on a basis of the node where the maximum node value is detected. In one example, the at least one node positioned within the set range can be defined as eight nodes positioned in places closest to the node where the maximum node value is detected, without the node where the maximum node value is detected. That is, the nodes may be adjacent to the node where the maximum node value is detected. Also, the cells may be defined as a total of nine nodes including the node where the maximum node value is detected and eight nodes positioned in the places closest to the node where the maximum node value is detected.

After that, in step 904, the electronic device counts the number of nodes in the set range or set region that have node values equal to or greater than a set percentage of the maximum node value and determines if the number of nodes is less than a set count (i.e., a threshold). That is, the electronic device identifies the number of nodes having node values equal to or greater than the set percentage of the maximum node value from the nodes in the set range. After identifying the number of nodes having node values equal to or greater than the set percentage of the maximum node value are detected among eight nodes positioned in the closest places on a basis of the node where the maximum node value is detected, the electronic device identifies the number of nodes, thereby determining whether to receive an input of a touch region on the node where the maximum node value is detected. In more detail, the electronic device determines if the number of nodes where the node values equal to or greater than the set percentage of the maximum node value are detected among the nodes within the set range is less than the set count at step 904.

If it is determined in step 904 that the number of nodes where the node values equal to or greater than the set percent of the maximum node value are detected among the nodes within the set range is less than the set count, in step 905, the electronic device receives an input of a touch region on the node where the maximum node value is detected and executes a function to be performed. In more detail, if it is determined in step 904 that the number of nodes where the node values equal to or greater than the set percentage of the maximum node value are detected among the nodes within the set range is less than the set count, the electronic device determines that it has received an input of a true touch, receives an input of a touch region on the node where the maximum node value is detected, and executes a function to be performed. Also, if it is determined in step 902 that the maximum node value is equal to or is greater than the set node value, the electronic device jumps to step 905 and also receives an input of a touch region on the node where the maximum node value is detected, and performs a function to be performed.

If it is determined in step 904 that the number of nodes where the node values equal to or greater than the set percentage of the maximum node value are detected among the nodes within the set range is equal to or is greater than the set count, in step 906, the electronic device does not receive an input of a touch region on the node where the maximum node value is detected, and the process ends.

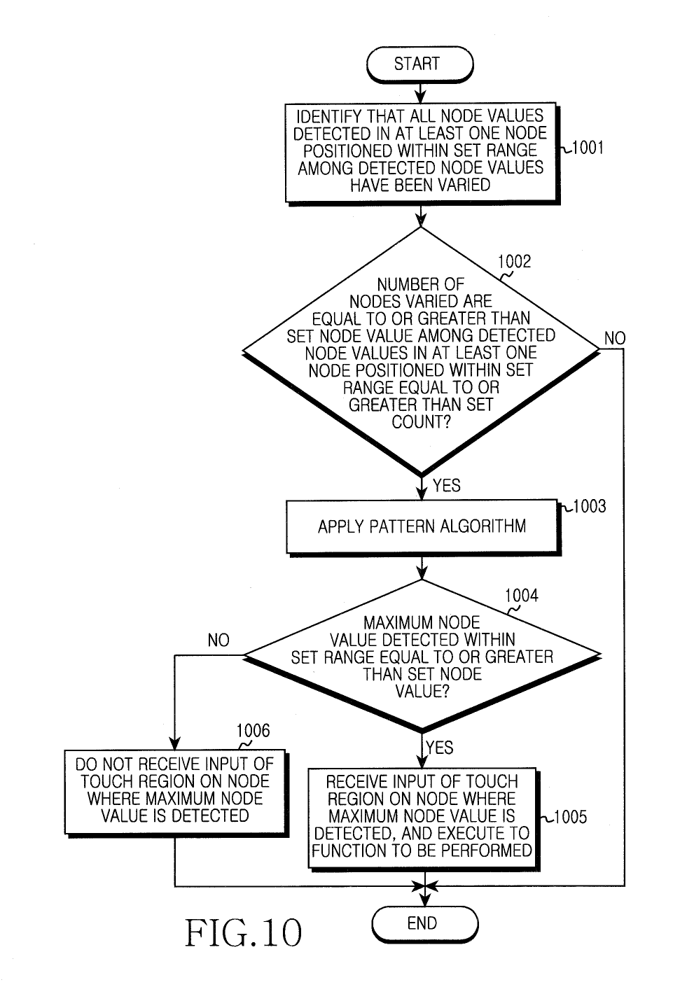

FIG. 10 is a flowchart illustrating a pattern algorithm according to an exemplary embodiment of the present invention.

Referring to FIG. 10, in step 1001, an electronic device identifies that all node values detected in at least one node positioned within a set range among detected node values have been varied. In more detail, the electronic device identifies, by X channel, that all node values detected in at least one node positioned in a corresponding X channel among provided at least one node have been varied. In this example, the nodes within the set range may include all nodes included in at least one X channel. That is, the electronic device determines whether to apply the pattern algorithm only when the electronic device identifies, by each X channel, that all node values included in a corresponding X channel among a plurality of provided X channels have been varied. If it is identified by X channel that all node values included in a corresponding X channel have been varied, the exemplary detection algorithm determines if a touch input is a true input or a false input, thereby preventing a problem being caused by erroneous operation.

After that, in step 1002, the electronic device determines if a number of nodes varied equal to or greater than a set node value within the set range of nodes is equal to or is greater than a set count. That is, if the electronic device identifies that all node values included in a corresponding X channel vary, the electronic device determines if that the node values within the set range are changed to be equal to or greater than the set node value, counts the number of nodes having node values equal to or greater than the set node value, and determines if the number of counted nodes is equal to or is greater than the set count. In more detail, the electronic device identifies the number of nodes having node values equal to or greater than the set node value from all node values in the X channel then and applies the pattern algorithm when the number of nodes having the node values equal to or greater than the set node value among the node values provided in the X channel is equal to or is greater than the set count.

If it is determined that the number of nodes having node values equal to or greater than the set node value within the set range is equal to or is greater than the set count, in step 1003, the electronic device applies an exemplary pattern algorithm for determining whether a touch input is a true input or a false input.

Next, after applying the pattern algorithm, in step 1004, the electronic device determines if a maximum node value detected within the set range is equal to or is greater than the set node value. That is, after applying the pattern algorithm, the electronic device searches the maximum node value among the scaled node values of the X channel to which the pattern algorithm is applied, and determines whether the maximum node value among the node values is equal to or greater than or is less than the set node value.

If it is determined in step 1004 that the maximum node value is equal to or is greater than the set node value from the node values of the X channel to which the pattern algorithm is applied, in step 1005, the electronic device determines to receive an input of a touch region on a node where the maximum node value is detected and executes a function to be performed.

If it is determined in step 1004 that the maximum node value is less than the set node value among the node values of the X channel to which the pattern algorithm is applied, in step 1006, the electronic device does not receive an input of a touch region on a node where the maximum node value is detected, and terminates the touch detection.

Also, if it is determined in step 1002 that the number of nodes varied among the X channel, which have node values equal to or greater than the set node value, is less than the set count, the electronic device just terminates the touch detection without applying the pattern algorithm.

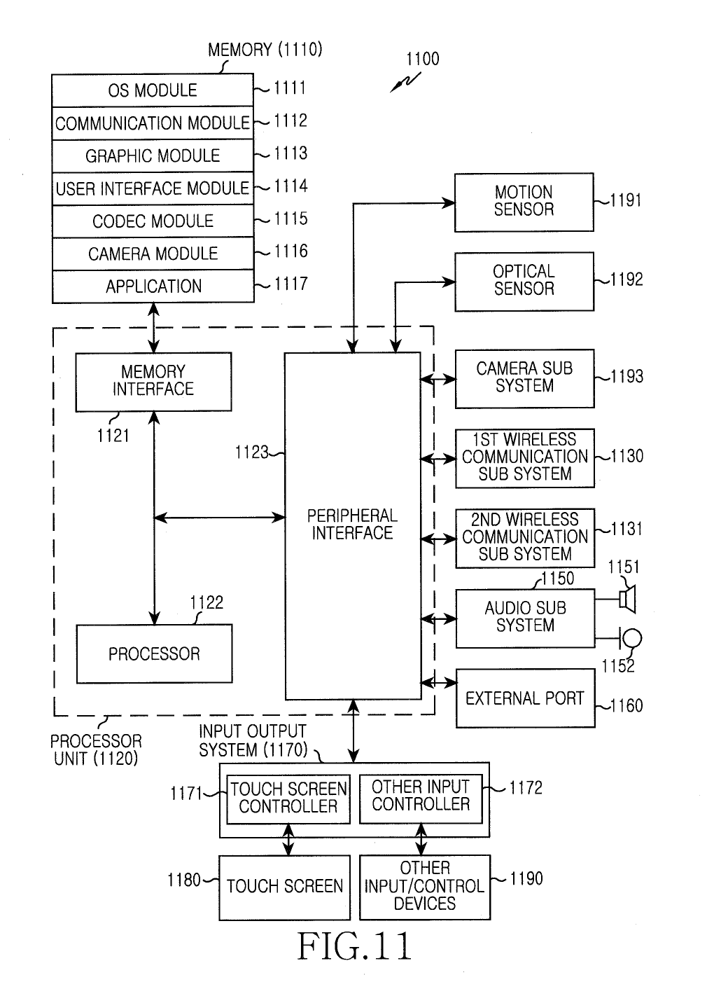

FIG. 11 is a block diagram illustrating a construction of an electronic device according to an exemplary embodiment of the present invention.

Referring to FIG. 11, an electronic device 1100 can be a portable electronic device such as a portable terminal, a mobile phone, a mobile pad, a media player, a tablet computer, a handheld computer, or a Personal Digital Assistant (PDA). Also, the electronic device may be any portable electronic device including a device having a combination of two or more functions among these devices.

The electronic device 1100 includes a memory 1110, a processor unit 1120, a 1st wireless communication sub system 1130, a 2nd wireless communication sub system 1131, an audio sub system 1150, a speaker 1151, a microphone 1152, an external port 1160, an Input Output (IO) sub system 1170, a touch screen 1180, and other input or control devices 1190. The memory 1110 and the external port 1160 can include plural devices such as different memories and different ports, for example.

The processor unit 1120 can include a memory interface 1121, one or more processors 1122, and a peripheral interface 1123. As described herein, the processor unit 1120 may also be referred to as a processor. In an exemplary embodiment of the present invention, the processor unit 1120 identifies each node value detected in at least one node positioned within a range that is set on a basis of a node where a maximum node value is detected, identifies the number of nodes having node values equal to or greater than a set percentage of the maximum node value within the set range and, by identifying the number of nodes, determines whether to receive an input of a touch region on the node where the maximum node value is detected. Also, the processor unit 1120 identifies each node value in at least one node, identifies that the detected node values have been varied, and searches for nodes to identify a node where the maximum node value is detected. Also, the processor unit 1120 determines if the maximum node value is equal to or is greater than a set node value and executes a function to be performed by receiving an input of the touch region. Also, the processor unit 1120 identifies that all node values detected in at least one node positioned within a set range among the detected node values have been varied, identifies the varied node value, and determines whether to receive an input of a touch region on at least one node positioned within the set range. Also, the processor unit 1120 identifies all node values detected within the set range from node values that have changed, determines that the node values within the set range to be equal to or greater than the set node value, and determines if the number of nodes having node values equal to or greater than the set node value is equal to or is greater than a set count. Also, the processor unit 1120 applies the pattern algorithm to at least one node positioned within the set range and identifies the varied node values in nodes positioned within the set range as a result of applying the pattern algorithm. Also, the processor unit 1120 searches for nodes proximate to the maximum node value within the set range, identifies that the maximum node value is equal to or is greater than the set node value, and executes a function to be performed by receiving an input of a touch region. Also, the processor unit 1120 identifies varied node values in nodes within the set range as a result of applying the pattern algorithm, searches for nodes for the maximum node value, and identifies that the maximum node value is less than the set node value.

The processor 1122 executes various software programs to perform various functions for the electronic device 1100, and also performs processing and control for voice communication and data communication. In addition to these general functions, the processor 1122 executes a specific software module (i.e., an instruction set) stored in the memory 1110 and performs specific functions corresponding to the software module. That is, the processor 1122 may implement a method of an exemplary embodiment of the present invention in conjunction with the software modules stored in the memory 1110.

The processor 1122 can include one or more data processors, image processors, or COder/DECoders (CODECs). The data processor, the image processor, or the CODEC may be constructed separately. Also, the processor 1122 may be constructed as several processors performing different functions. The peripheral interface 1123 connects the IO sub system 1170 of the electronic device 1100 and various peripheral devices thereof to the processor 1122. Further, the peripheral interface 1123 connects the IO sub system 1170 of the electronic device 1100 and the various peripheral devices thereof to the memory 1110 through the memory interface 1121.

Various structures of the electronic device 1100 can be coupled with one another by one or more communication buses (not denoted by reference numerals) or stream lines (not denoted by reference numerals).

The external port 1160 connects the electronic device 1100 to other electronic devices or indirectly connects the electronic device 1100 to other electronic devices through a network (for example, the Internet, an intranet, a Wireless Local Area Network (WLAN) and the like). For example, the external port 1160 refers to, although not limited to, a Universal Serial Bus (USB) port, a Firewire® port or the like.

A motion sensor 1191 and an optical sensor 1192 are coupled to the peripheral interface 1123 and enable various functions. For instance, the motion sensor 1191 and the optical sensor 1192 can be coupled to the peripheral interface 1123, and sense a motion of the electronic device 1100 and sense a light from the environment, respectively. In addition to this, other sensors such as a global positioning system, a temperature sensor, a biological sensor or the like can be coupled to the peripheral interface 1123 to perform related functions.

A camera sub system 1193 can perform a camera function such as photograph and video clip recording.

The optical sensor 1192 can use a Charged Coupled Device (CCD) device or Complementary Metal-Oxide Semiconductor (CMOS) device.

The 1st and 2nd wireless communication sub systems 1130 and 1131 enable a communication function. The 1st and 2nd wireless communication sub systems 1130 and 1131 can include a radio frequency receiver and transceiver and/or an optical (e.g., infrared) receiver and transceiver. The 1st and 2nd communication sub systems 1130 and 1131 can be distinguished according to a communication network in which the electronic device 1100 communicates. For example, the communication network can include a communication sub system designed to operate through, although not limited to, a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (Wi-Fi) network, a Wireless interoperability for Microwave Access (WiMAX) network, a Bluetooth network or/and the like.

The audio sub system 1150 is coupled to the speaker 1151 and the microphone 1152, to input and output an audio stream such as voice recognition, voice copy, digital recording, and a call function. That is, the audio sub system 1150 communicates with a user through the speaker 1151 and the microphone 1152. The audio sub system 1150 receives a data stream through the peripheral interface 1123 of the processor unit 1120, converts the received data stream into an electric signal, and forwards the converted electric signal to the speaker 1151. The speaker 1151 converts the electric signal into a sound wave audible by a person and outputs the converted sound wave. The microphone 1152 converts a sound wave from the person or other sound sources into an electric signal. The audio sub system 1150 receives a converted electric signal from the microphone 1152. The audio sub system 1150 converts the received electric signal into an audio data stream, and transmits the converted audio data signal to the peripheral interface 1123. The audio sub system 1150 can include a detachable earphone, headphone or headset.

The IO sub system 1170 includes a touch screen controller 1171 and/or other input controller 1172. The touch screen controller 1171 can be coupled to the touch screen 1180. The touch screen 1180 and the touch screen controller 1171 can detect a contact and a motion or an interruption thereof using not only capacitive, resistive, infrared and surface acoustic wave technologies for determining one or more contact points with the touch screen 1180, but also any multi-touch sensing technology including other proximity sensor arrays or other suitable elements. The other input controller 1172 can be coupled to the other input/control devices 1190. The other input/control devices 1190 can be at least one or more buttons, a rocker switch, a thumb-wheel, a dial, a stick, a pointer device such as a stylus and/or the like.

The touch screen 1180 provides an input output interface between the electronic device 1100 and a user. That is, the touch screen 1180 forwards a user's touch input to the electronic device 1100. Also, the touch screen 1180 is a medium for displaying an output of the electronic device 1100 to the user. That is, the touch screen 1180 receives input from a user and provides a visual output to the user. This visual output can be presented in a form of a text, a graphic, a video, and a combination thereof.

The touch screen 1180 can use various displays. For example, the touch screen 1180 can use, although not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). In an exemplary embodiment of the present invention, if it is determined that a maximum node value is equal to or is greater than a set node value, the touch screen 1180 receives an input of a touch region on a node where the maximum node value is detected. If it is determined that a number of nodes, which are proximate to the node having the maximum node value and have node values that exceed another set node value, is less than a set count, the touch screen 1180 receives the input of the touch region on the node where the maximum node value is detected. Also, if it is determined that the maximum node value is equal to or is greater than the set node value, the touch screen 1180 receives an input of a touch region on at least one node positioned within a set range and, if it is determined that the maximum node value is less than the set node value, the touch screen 1180 does not receive the input of the touch region on at least one node positioned within the set range.

The memory 1110 is coupled to the memory interface 1121. The memory 1110 can include one or more high-speed random access memories and/or non-volatile memories such as magnetic disk storage devices, one or more optical storage devices and/or flash memories (for example, Not AND (NAND) memories, Not OR (NOR) memories).

The memory 1110 stores software. The software includes an Operating System (OS) module 1111, a communication module 1112, a graphic module 1113, a user interface module 1114, CODEC module 1115, a camera module 1116, one or more application modules 1117, a face recognition module (not shown) and the like. Also, because the modules, which may be implemented via software, can be expressed as a set of instructions, the module is also called an instruction set. The module is also called an application program that a user selectively executes. In an exemplary embodiment of the present invention, the memory 1110 stores electronic contents and input at least one display together, stores a moving picture of an extracted duration, stores electronic contents and input highlight display together, creates a highlight list, calls a stored highlight list, and calls a stored drawing list. The OS software 1111 represents a operating system such as Windows®, LINUX, Darwin, RTXC, UNIX, OS X®, or VxWorks®, and includes various software application for controlling general system operation. Control of the general system operation includes memory management and control, storage hardware (device) control and management, power control and management and the like. Further, the OS software 1111 performs functions related to communication between various hardware (devices) and software (modules).

The communication module 1112 can enable communication with other electronic device such as a personal computer, a server, a portable terminal and/or the like, through the 1st and 2nd wireless communication sub systems 1130 and 1131 or the external port 1160.

The graphic module 1113 includes software for providing and displaying a graphic on the touch screen 1180. The term ‘graphic’ is used as meaning including a text, a web page, an icon, a digital image, a video, an animation and the like.

The user interface module 1114 includes various software constituent elements associated with a user interface. Further, the user interface module 1114 includes information about how a state of the user interface is changed and in which conditions the change of the state of the user interface is carried out, and the like.

The CODEC module 1115 can include a software constituent element related to encoding and decoding of a video file. The CODEC module 1115 can include a video stream module such as an MPEG module and/or H204 module. Also, the CODEC module can include several audio file CODEC modules such as AAA, AMR, WMA and the like. Also, the CODEC module 1115 includes an instruction set corresponding to an implementation method of an exemplary embodiment of the present invention.

The camera module 1116 includes a camera related software constituent element enabling camera-related processes and functions.

The application module 1117 includes a browser, an electronic mail (e-mail), an instant message, word processing, keyboard emulation, an address book, a touch list, a widget, Digital Right Management (DRM), voice recognition, voice copy, a location determining function, a location-based service and the like.

Also, various functions of the electronic device 1100 according to an exemplary embodiment of the present invention mentioned above and to be mentioned below can be executed by hardware including one or more stream processing and/or Application Specific Integrated Circuits (ASICs), and/or software, and/or a combination of hardware and software.

According to an electronic device for preventing a false touch and a method thereof, there is an effect of providing an apparatus and method for determining whether an input touch is a true touch or a false touch, and preventing unintended erroneous operation.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operation method of an electronic device, the method comprising:
identifying each node value detected in at least one node positioned in a range that is set on a basis of a node where a maximum node value is detected;
identifying a number of nodes where node values equal to or greater than a set percentage of the maximum node value are detected among nodes within the set range; and
based on the number of nodes, determining whether to receive an input of a touch region on the node where the maximum node value is detected.

2. The method of claim 1, further comprising:
identifying a node value detected in at least one node;
identifying that the detected node value has been varied; and
searching for the detected maximum node value among the at least one node.

3. The method of claim 1, further comprising:
determining if the maximum node value is equal to or is greater than a set node value;
if it is determined that the maximum node value is equal to or is greater than the set node value, receiving the input of the touch region on the node where the maximum node value is detected; and
executing a function to be performed by receiving the input of the touch region.

4. The method of claim 1, wherein the at least one node positioned within the set range is eight nodes positioned closest to the node where the maximum node value is detected.

5. The method of claim 1, wherein, based on the number of nodes, determining whether to receive the input of the touch region on the node where the maximum node value is detected comprises:
if the number of nodes is less than a set count, receiving the input of the touch region on the node where the maximum node value is detected; and
executing a function to be performed by receiving the input of the touch region.

6. The method of claim 1, wherein, based on the number of nodes, determining whether to receive the input of the touch region on the node where the maximum node value is detected further comprises, if the number of nodes is equal to or is greater than the set count, not receiving the input of the touch region on the node where the maximum node value is detected.

7. The method of claim 1, wherein each node is an intersection of at least one X channel and at least one Y channel.

8. An operation method of an electronic device, the method comprising:
identifying that all node values detected in at least one node positioned in a set range among detected node values have been varied; and
identifying the varied node value and determining whether to receive the input of the touch region on at least one node positioned within the set range.

9. The method of claim 8, further comprising identifying each node value detected in at least one node.

10. The method of claim 8, wherein the at least one node positioned within the set range includes all nodes in at least one X channel.

11. The method of claim 8, wherein the identifying of all node values detected in the at least one node positioned within the set range among the detected node values have been varied further comprises:
identifying that the node value detected in the at least one node positioned within the set range has been varied equal to or greater than a set node value; and
identifying that a number of nodes varied equal to or greater than the set node value is equal to or is greater than a set count.

12. The method of claim 8, wherein the identifying of the varied node value and determining whether to receive the input of the touch region on the at least one node positioned within the set range comprises:
applying a pattern algorithm to at least one node positioned within the set range; and
as a result of applying the pattern algorithm, identifying the varied node value detected in the at least one node positioned within the set range.

13. The method of claim 12, wherein the pattern algorithm is defined according to the following equation:
$$A - \frac{C}{B}$$
wherein A denotes each node value detected in each node, B denotes a value subtracting ‘1’ from the number of nodes within the set range, and C denotes a value subtracting a maximum node value among node values detected in nodes within the set range from a total sum of the node values detected in nodes within the set range.

14. The method of claim 12, wherein the identifying of the varied node value detected in the at least one node positioned within the set range as the result of applying the pattern algorithm comprises:
searching for any one node where a maximum node value among node values detected in at least one node positioned within the set range is detected;
identifying that the maximum node value is equal to or is greater than a set node value;
receiving an input of a touch region on at least one node positioned within the set range; and
executing a function to be performed by receiving the input of the touch region.

15. The method of claim 12, wherein the identifying of the varied node value detected in at least one node positioned within the set range as the result of applying the pattern algorithm comprises:
searching for any one node where a maximum node value among nodes values detected in at least one node positioned within the set range is detected;
identifying that the maximum node value is less than a set node value; and
not receiving the input of the touch region on the at least one node positioned within the set range.

16. The method of claim 8, wherein the node is at an intersection of at least one X channel and at least one Y channel.

17. An electronic device comprising:
a processor unit for identifying each node value detected in at least one node positioned in a range that is set on a basis of a node where a maximum node value is detected, identifying a number of nodes where node values equal to or greater than a set percentage of the maximum node value are detected among nodes within the set range and, based on the number of nodes, determining whether to receive an input of a touch region on the node where the maximum node value is detected; and
a memory for storing information controlled in the processor unit.

18. The device of claim 17, wherein the processor unit identifies a node value detected in at least one node, identifies that the detected node values have been varied, and searches for any one node where the maximum node value is detected among the at least one node.

19. The device of claim 17, wherein the processor unit determines if the maximum node value is equal to or is greater than a set node value, and executes a function to be performed by receiving the input of the touch region, and
further comprising a touch screen for, if it is determined that the maximum node value is equal to or is greater than the set node value, receiving the input of the touch region on the node where the maximum node value is detected.

20. The device of claim 17, wherein the at least one node positioned within the set range is eight nodes closest to the node where the maximum node value is detected.

21. The device of claim 17, further comprising a touch screen for, if it is determined that the number of nodes is less than a set count, receiving the input of the touch region on the node where the maximum node value is detected,
wherein the processor unit executes a function to be performed by receiving the input of the touch region.

22. The device of claim 17, wherein, if it is determined that the number of nodes is equal to or is greater than the set count, the touch screen does not receive the input of the touch region on the node where the maximum node value is detected.

23. The device of claim 17, wherein the node is at an intersection of at least one X channel and at least one Y channel.

24. An electronic device comprising:
a processor unit for identifying that all node values detected in at least one node positioned in a set range among detected node values have been varied and, by identifying the varied node value, determining whether to receive an input of a touch region on at least one node positioned within the set range; and
a memory for storing information controlled in the processor unit.

25. The device of claim 24, wherein the processor unit identifies each node value detected in at least one node.

26. The device of claim 24, wherein the at least one node positioned within the set range includes all nodes in at least one X channel.

27. The device of claim 24, wherein the processor unit identifies that all node values detected in the at least one node positioned within the set range among the detected node values have been varied, identifies that the node value detected in the at least one node positioned within the set range has been varied equal to or greater than a set node value, and identifies that the node varied equal to or greater than the set node value is equal to or is greater than a set count.

28. The device of claim 24, wherein the processor unit applies a pattern algorithm to at least one node positioned within the set range and, as a result of applying the pattern algorithm, identifies the varied node value detected in the at least one node positioned within the set range.

29. The device of claim 28, wherein the pattern algorithm is defined according to the following equation:
$$A - \frac{C}{B}$$
wherein A denotes each node value detected in each node, B denotes a value subtracting ‘1’ from the number of nodes within set range, and C denotes a value subtracting a maximum node value among the node values detected in nodes within the set range from a total sum of the node values detected in nodes within set range.

30. The device of claim 28, wherein the processor unit searches for any one node where a maximum node value among node values detected in at least one node positioned within the set range is detected, identifies that the maximum node value is equal to or is greater than a set node value, and executes a function to be performed by receiving the input of the touch region,
further comprising a touch screen for receiving the input of the touch region on at least one node positioned within the set range.

31. The device of claim 28, wherein the processor unit identifies the varied node value detected in at least one node positioned within the set range as the result of applying a pattern algorithm, searches for any one node where a maximum node value among nodes values detected in at least one node positioned within the set range is detected, and identifies that the maximum node value is less than a set node value,
further comprising a touch screen not receiving the input of the touch region on the at least one node positioned within the set range.

32. The device of claim 24, wherein the node is at an intersection of at least one X channel and at least one Y channel.
